(19) United States
(12) Patent Application Publication
(10) Pub. No.: US 2003/0050948 A1
(43) Pub. Date: Mar. 13, 2003

(54) Floating-point remainder computing unit, information processing apparatus and storage medium

(75) Inventor: Yasukichi Okawa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/103,897

(22) Filed: Mar. 25, 2002

(30) Foreign Application Priority Data
Sep. 7, 2001 (JP) 2001-272599

(51) Int. Cl. G06F 7/44

(52) U.S. Cl. 708/504

(57) ABSTRACT

A floating-point remainder computing unit computes a remainder R, by obtaining an integer quotient by rounding a floating-point variable C which is obtained from A÷B and judging whether the remainder R can be obtained accurately, separately processing mantissa and exponent parts of floating-point variables B and C and separately obtaining the mantissa part Rf and the exponent part Re of the remainder R if the remainder R can be obtained accurately, and carrying out a floating-point add-subtract process which obtains the remainder R from A−B if C=+1 and A+B if C=−1 if the remainder R cannot be obtained accurately.

### BACKGROUND OF THE INVENTION

This application claims the benefit of a Japanese Patent Application No.2001-272599 filed Sep. 7, 2001, in the Japanese Patent Office, the disclosure of which is hereby incorporated by reference.

### FIELD OF THE INVENTION

The present invention generally relates to floating-point remainder computer units, information processing apparatuses and storage media, and more particularly to a floating-point type floating-point remainder computing unit which carries out a rounding process in a plurality of rounding modes prescribed by the IEEE754 standard, an apparatus such as an information processing apparatus which forms a computer such as a microprocessor provided with such a floating-point remainder computing unit, and a computer-readable storage medium which stores a program for causing a computer to carry out such a floating-point remainder computing.

### DESCRIPTION OF THE RELATED ART

FIG. 1 is a system block diagram showing the construction of a conventional floating-point remainder computing unit which obtains a remainder of a floating-point number with respect to a floating-point dividend A and a floating-point divisor B. In FIG. 1, a floating-point divider 1 obtains a quotient by carrying out A÷B. A rounding unit 2 which rounds the quotient into an integer. More particularly, the rounding unit 2 outputs a quotient C which is obtained by rounding the quotient obtained by the floating-point remainder computing unit 1 into an integer by a specified rounding mode. A floating-point product-sum computing unit 3 computes A−B×C, and obtains a remainder by rounding a result by a given remainder rounding mode.

FIG. 2 is a system block diagram showing details of the floating-point product-sum computing unit 3 shown in FIG. 1. In FIG. 2, As denotes a sign of the floating-point dividend A, Ae denotes an exponent of the floating-point dividend A, Af denotes a mantissa of the floating-point dividend A, Bs denotes a sign of the floating-point divisor B, Be denotes an exponent of the floating-point divisor B, Bf denotes a mantissa of the floating-point divisor B, Cs denotes a sign of the quotient C, Ce denotes an exponent of the quotient C, Cf denotes a mantissa of the quotient C, and BIAS denotes a bias value of an exponent part of the floating-point number. In addition, it is assumed that n denotes a number of bits of a mantissa part. A product-sum result is obtained in the following manner.

In FIG. 2, a multiplier 12 obtains a multiplication result of Bf and Cf. Next, a subtraction is made from the mantissa part of the dividend A to obtain the remainder, but in the floating-point representation, the mantissa part is not represented by the two's compliment representation and is represented by “(sign)+(absolute value representation)”. Accordingly, whether a subsequent subtraction of the mantissa part is an addition or a subtraction depends on As and (B×C)s. The subsequent subtraction of the mantissa is a subtraction if As and (B×C)s have the same sign, and is an addition if As and (B×C)s have different signs. In the case where As and (B×C)s have the same sign and the subsequent subtraction of the mantissa is the subtraction, an inverter 15 obtains an inversion of Bf×Cf, and by carrying out an addition by inputting a carry CIN from an exclusive-NOR circuit 21 to a least significant position of an absolute value adder 13, it is possible to obtain the same effect as adding the two's compliment of Bf×Cf. On the other hand, such an operation is not carried out in the case where As and (B×C)s have the different signs because the subsequent subtraction of the mantissa is the addition. The multiplication result is an intermediate result of the product-sum operation, and since no loss of accuracy can be tolerated, the multiplication result is obtained in 2n bits. At the same time, an operation Be+Ce−BIAS is carried out in a computing unit 17 with respect to the exponent Be and Ce, so as to carry out an exponent process of the multiplication. Further, a sign of the multiplication result is obtained by computing an exclusive-OR of Bs and Cs in an exclusive-OR circuit 16. An absolute value adder 13 adds Af and Bf×Cf.

However, an exponent different exists between Af and Bf×Cf, and the two cannot be added as they are. Hence, a left-right shifter (hereinafter referred to as an aligner) 11 aligns Af to the exponent position of Bf×Cf based on a comparison result of a comparator 19, before carrying out the addition in the absolute value adder 13. A shift direction in this case is as shown in FIG. 3. FIG. 3 is a diagram for explaining the shift direction of Af. In other words, the alignment is made to the left when Ae>Be+Ce−BIAS, the alignment is made to the right when Ae<Be+Ce−BIAS, and the amount of the shift is |Ae−(Be+Ce−BIAS|. From the nature of the remainder operation, the alignment to the left is within 2 bits at the most, but the alignment to the right can be a maximum of 2n−1 bits. A sign of an addition result is determined in a selector 18 according to a table shown in FIG. 4, using As, B×C, and a carry out COUT of the absolute value adder 13, and this sign becomes the sign of the final result. FIG. 4 is a diagram showing the table for determining the sign of the addition result.

A normalization and rounding unit 14 counts a number of consecutive bits which are “0” on the left of Af±Bf×Cf which is made up of 2n bits, and subjects Af'Bf×Cf to a left-shift using the counted number of bits as a normalization shift amount. Next, the mantissa part subjected to the normalization shift is rounded at the (n+1)th bit using a rounding mode specified by the remainder rounding mode. If the carry propagates the mantissa part and the most significant position increases by 1 bit as a result of the rounding, the mantissa part is shifted by 1 bit to the right to align the position. The normalization shift amount to the left in the normalization and rounding unit 14 is supplied to an exponent part subtracter 20 and subtracted from Be+Ce−BIAS, to thereby obtain the exponent part of the final result.

By the steps described above, it is possible to apply different rounding modes for the rounding process carried out when obtaining the integer quotient and for the rounding process carried out when obtaining the remainder.

The product-sum operation carried out in the floating-point remainder operation subtracts from the dividend the multiplication result of the divisor and the integer quotient, but the result of these operations must match a result which is obtained by rounding a result of carrying out the operation with infinite accuracy. Accordingly, in FIG. 2, the mantissa part of the multiplication result in the floating-point multiplier 12 needs to have an accuracy of 2n bits, and the aligner 11 must be able to carry out a maximum left-shift of 1 bit and a maximum right-shift of 2n−1 bits. The absolute value adder 13 must be able to accept a 2b-bit operand.

However, the floating-point adders and aligners (shifters) which are standard equipment in the processors of the computers and the like are only designed to treat an n-bit operand. For this reason, circuits such as the aligner 11 and the absolute value adder 13 shown in FIG. 2 must be provided additionally, and there was a problem in that this greatly increases the amount of circuits to be provided additionally to the standard equipment.

### SUMMARY OF THE INVENTION

Accordingly, it is a general object of the present invention to provide a novel and useful floating-point remainder computing unit, information processing apparatus and storage medium, in which the problems described above are eliminated.

Another and more specific object of the present invention is to provide a floating-point remainder computing unit, an information processing apparatus and a storage medium, which can effectively utilize floating-point adders and aligners (shifters) which are standard equipment in information processing apparatuses such as processors of computers, and realize a floating-point remainder operation by simply adding only a small amount of circuits in addition to the standard equipment.

Still another object of the present invention is to provide a floating-point remainder computing unit for computing a remainder R, where floating-point variables are denoted by A, B, C and R, an exponent part and a mantissa part of the floating-point variable R are respectively denoted by Re and Rf, an integer quotient obtained by rounding a quotient of A÷B is denoted by C, and the floating-point remainder computing unit comprising a judging section for obtaining the integer quotient by the variable C by rounding the floating-point variable C which is obtained from A÷B, and judging whether or not the remainder R can be obtained accurately, based on a comparison result of the variable C and ±1; a first operation section for separately processing mantissa parts and exponent parts of the floating-point variables B and C, and separately obtaining the mantissa part Rf and the exponent part Re of the remainder R, if the judging section judges that the remainder R can be obtained accurately; and a second operation section for carrying out a floating-point add-subtract process which obtains the remainder R from A−B if C=+1 and obtains the remainder R from A+B if C=−1, if the judging section judges that the remainder R cannot be obtained accurately. According to the floating-point remainder computing unit of the present invention, it is possible to effectively utilize floating-point adders and aligners (shifters) which are standard equipment in information processing apparatuses such as processors of computers, and realize a floating-point remainder operation by simply adding only a small amount of circuits in addition to the standard equipment.

A further object of the present invention is to provide an apparatus comprising a floating-point operation unit having a floating-point remainder computing unit for computing a remainder R, where floating-point variables are denoted by A, B, C and R, an exponent part and a mantissa part of the floating-point variable R are respectively denoted by Re and Rf, an integer quotient obtained by rounding a quotient of A÷B is denoted by C, and the floating-point remainder computing unit comprises a judging section for obtaining the integer quotient by the variable C by rounding the floating-point variable C which is obtained from A÷B, and judging whether or not the remainder R can be obtained accurately, based on a comparison result of the variable C and ±1; a first operation section for separately processing mantissa parts and exponent parts of the floating-point variables B and C, and separately obtaining the mantissa part Rf and the exponent part Re of the remainder R, if the judging section judges that the remainder R can be obtained accurately; and a second operation section for carrying out a floating-point add-subtract process which obtains the remainder R from A−B if C=+1 and obtains the remainder R from A+B if C=−1, if the judging section judges that the remainder R cannot be obtained accurately. According to the apparatus of the present invention, it is possible to effectively utilize floating-point adders and aligners (shifters) which are standard equipment in information processing apparatuses such as processors of computers, and realize a floating-point remainder operation by simply adding only a small amount of circuits in addition to the standard equipment.

Another object of the present invention is to provide a computer-readable storage medium which stores a computer program for causing a computer to carry out a floating-point remainder operation which computes a remainder R, where floating-point variables are denoted by A, B, C and R, an exponent part and a mantissa part of the floating-point variable R are respectively denoted by Re and Rf, an integer quotient obtained by rounding a quotient of A÷B is denoted by C, and the computer program comprises a judging procedure which causes the computer to obtain the integer quotient by the variable C by rounding the floating-point variable C which is obtained from A÷B, and judge whether or not the remainder R can be obtained accurately, based on a comparison result of the variable C and ±1; a first operation procedure which causes the computer to separately process mantissa parts and exponent parts of the floating-point variables B and C, and separately obtain the mantissa part Rf and the exponent part Re of the remainder R, if the judging procedure judges that the remainder R can be obtained accurately; and a second operation procedure which causes the computer to carry out a floating-point add-subtract process which obtains the remainder R from A−B if C=+1 and obtains the remainder R from A+B if C=−1, if the judging procedure judges that the remainder R cannot be obtained accurately. According to the computer-readable storage medium of the present invention, it is possible to effectively utilize floating-point adders and aligners (shifters) which are standard equipment in information processing apparatuses such as processors of computers, and realize a floating-point remainder operation by simply adding only a small modification to the standard equipment.

Other objects and further features of the present invention will be apparent from the following detailed description when read in conjunction with the accompanying drawings.

### BRIEF DESCRIPTION OF THE DRAWINGS

FIG. 1 is a system block diagram showing the construction of a conventional floating-point remainder computing unit which obtains a remainder of a floating-point number;

FIG. 2 is a system block diagram showing details of the floating-point product-sum computing unit shown in FIG. 1;

FIG. 3 is a diagram for explaining a shift direction of a mantissa of a dividend;

FIG. 4 is a diagram showing a table for determining a sign of an addition result;

FIG. 5 is a diagram for explaining a state where a remainder of a division is always accurately obtained;

FIG. 6 is a diagram for explaining a state where a remainder is accurately obtained even when a quotient is rounded up by a rounding;

FIG. 7 is a diagram for explaining that a shift amount for aligning a dividend by an add-subtract process of a product-sum operation is a maximum of ±1 bit;

FIG. 8 is a diagram for explaining a need for normalization of a remainder after an add-subtract process following multiplication in the product-sum operation;

FIG. 9 is a diagram for explaining that a normalization shift amount after the product-sum operation is predictable;

FIG. 10 is a system block diagram showing an important part of an embodiment of a product-sum operation circuit of a floating-point remainder computing unit according to the present invention;

FIG. 11 is a system block diagram showing an embodiment of an information processing apparatus according to the present invention;

FIG. 12 is a diagram for explaining an alignment of A and B;×C by an aligner shown in FIG. 11; and

FIG. 13 is a flow chart for explaining a computer program stored in an embodiment of a storage medium according to the present invention.

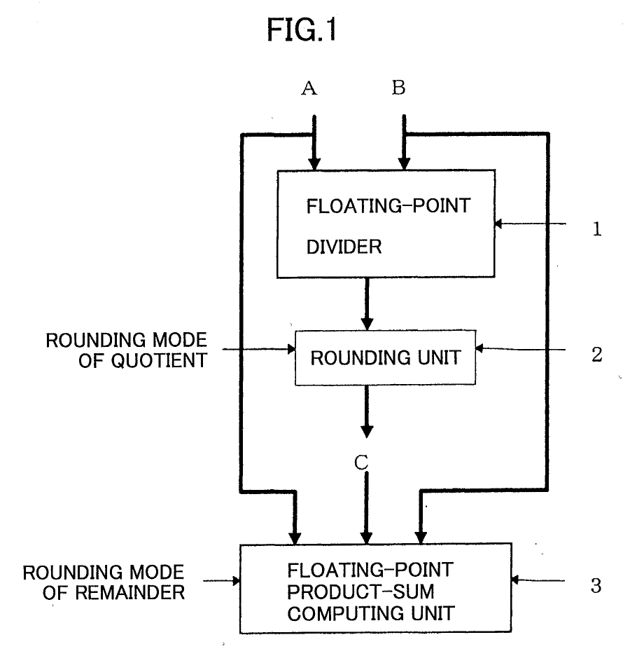

### DESCRIPTION OF THE PREFERRED EMBODIMENTS

A description will be given of embodiments of a floating-point remainder computing unit according to the present invention, an information processing apparatus according to the present invention, and a storage medium according to the present invention, by referring to FIG. 5 and the subsequent drawings.

First, a description will be given of the operating principle of the present invention, by referring to FIGS. 5 through 9.

A processor of a computer is provided with a floating-point unit (FPU), and a floating-point remainder computing unit is mounted in the FPU. The processor is provided with floating-point adder-subtracters and multipliers for an n-bit mantissa part, and it is a precondition that these floating-point adder-subtracters and multipliers can freely be used.

When a dividend A is denoted by A=1.x₀x₁x₂x₃x₄ . . . xₙ₋₁×2^{Ae} and a divisor B is denoted by B=1.y₀y₁y₂y₃y₄ . . . yₙ₋₁×2^{Be}, a division of the exponent part carries out Ae−Be+BIAS, and a division of the mantissa part carries out 1x₀x₁x₂x₃x₄ . . . xₙ₋₁÷1y₀y₁y₂y₃y₄ . . . yₙ₋₁ by omitting the decimal point. When this operation is made on paper, it becomes as shown in FIG. 5. FIG. 5 is a diagram for explaining a state where a remainder of a division is always accurately obtained. A case will be considered where an ith intermediate remainder is obtained in a state where an (i−1)th intermediate result w₀w₁w₂w₃ . . . wₙ is obtained.

If a partial quotient aᵢ=0, w₀=0. If not, the condition aᵢ=0 will not be satisfied. Accordingly, the intermediate remainder in this case becomes w₁w₂W₃W₄ . . . wₙ, and a relationship [bit width of ith intermediate remainder]≦[bit width of (i−1)th intermediate remainder] stands.

When the partial quotient aᵢ=1, a most significant bit z₀ of the ith remainder becomes 0. If not, the remainder would become larger than the divisor, meaning that aᵢ>1, which would not satisfy the condition aᵢ=1. Hence, the ith intermediate remainder becomes z₁z₂z₃z₄ . . . zₙ, and a relationship [bit width of ith intermediate remainder]≦[bit width of (i−1)th intermediate remainder] stands.

Therefore, in each step of making the division on paper, the relationship [bit width of ith intermediate remainder]≦[bit width of (i−1)th intermediate remainder] always stands.

The remainder for a case where i=0 is the dividend, and the bit width of the remainder of the division will not exceed the bit width of the dividend. For this reason, the remainder can always be obtained accurately. On the other hand, this of course does not apply to a case where the quotient obtained by the division is an integer quotient.

The method of obtaining the integer quotient depends on the rounding mode at the time of the division. For example, when obtaining the integer quotient by rounding up, “1” is added on the left side of the decimal point in the quotient after obtaining the decimal quotient, and the figures after the decimal point are rounded down. When obtaining the integer quotient by rounding down, the remainder is always obtained accurately. Hence, a case will now be considered where “1” is added on the left side of the decimal point in the quotient by the rounding.

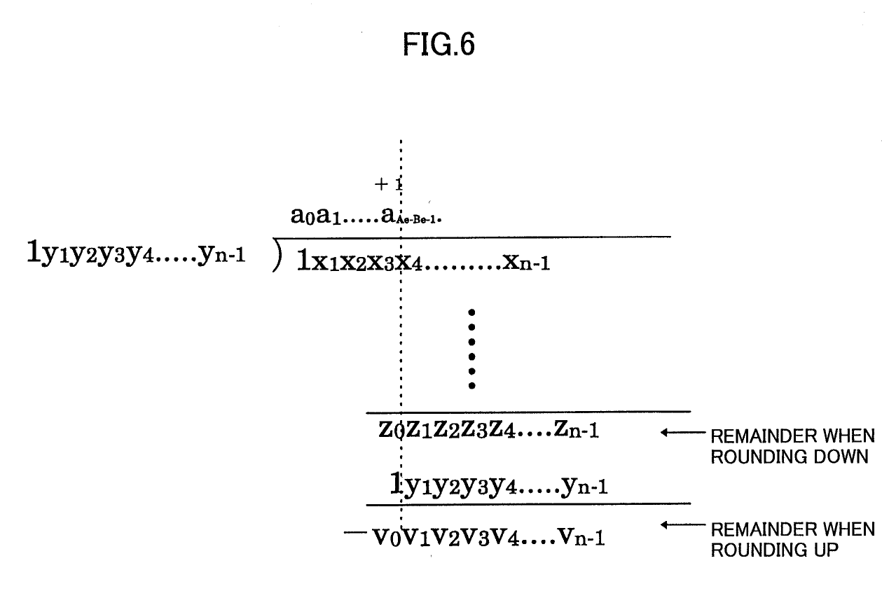

In a case where Ae>Be or Ae=Be and Af≦Bf, an absolute value of the integer quotient C becomes larger than 1. The remainder in this case is obtained by further subtracting the divisor from the remainder when the rounded down integer quotient is obtained as shown in FIG. 6. FIG. 6 is a diagram for explaining a state where the remainder is accurately obtained even when the quotient is rounded up by the rounding. A rounded up remainder −v₀v₁v₂ . . . vₙ₋₁ which is obtained in this manner has a bit width n, and can be represented accurately.

In a case where Ae<Be or Ae=Be and Af<Bf, the integer quotient becomes 0 when rounding down. When this integer quotient is rounded up, the quotient becomes ±1. Accordingly, the remainder at when rounding up becomes A−±1×B=A±B. In this state, if Ae<Be, the mantissa part of A may be aligned in the rightward direction when carrying out A±B, and the remainder may not be accurately obtained in some cases.

In view of the above, it may be concluded that “a case where the remainder cannot be accurately obtained by the floating-point remainder computing unit is limited to the case where A÷B is carried out such that Ae<Be and the quotient is rounded up to ±1”.

On the other hand, the integer quotient is not rounded up to ±1 when Ae<Be, for all of the plurality of rounding modes. In the case of the “Round To Nearest”, “Biased Round To Nearest” and “Toward zero”, the integer quotient is rounded down when Ae<Be. A case where the inaccurate remainder is obtained as described above is limited to the following combination.

The rounding mode is “Toward+∞” and the dividend and the divisor have the same sign.

The rounding mode is “Toward−∞” and the dividend and the divisor have different signs.

In a case where n=24, for example, 1.0×2⁻²⁵÷1.0=1.0×2⁻²⁵<<1.0 (binary representation). When this quotient is rounded by “Toward+∞”, the integer quotient becomes 1.0. Accordingly, the remainder becomes

1.0×2⁻²⁵−1.0×1.0=−0.1111111111111111111111111

and the mantissa part cannot be represented by n=24 bits, thereby obtaining the remainder which is inaccurate. A similar phenomenon occurs when the quotient is rounded by “Toward−∞” and the integer quotient is −1.

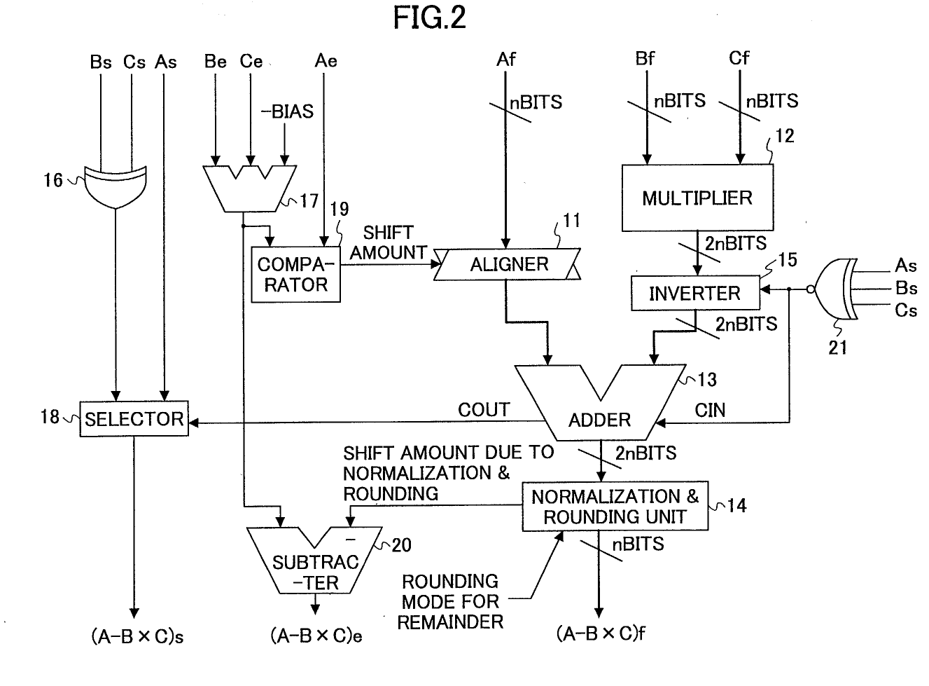

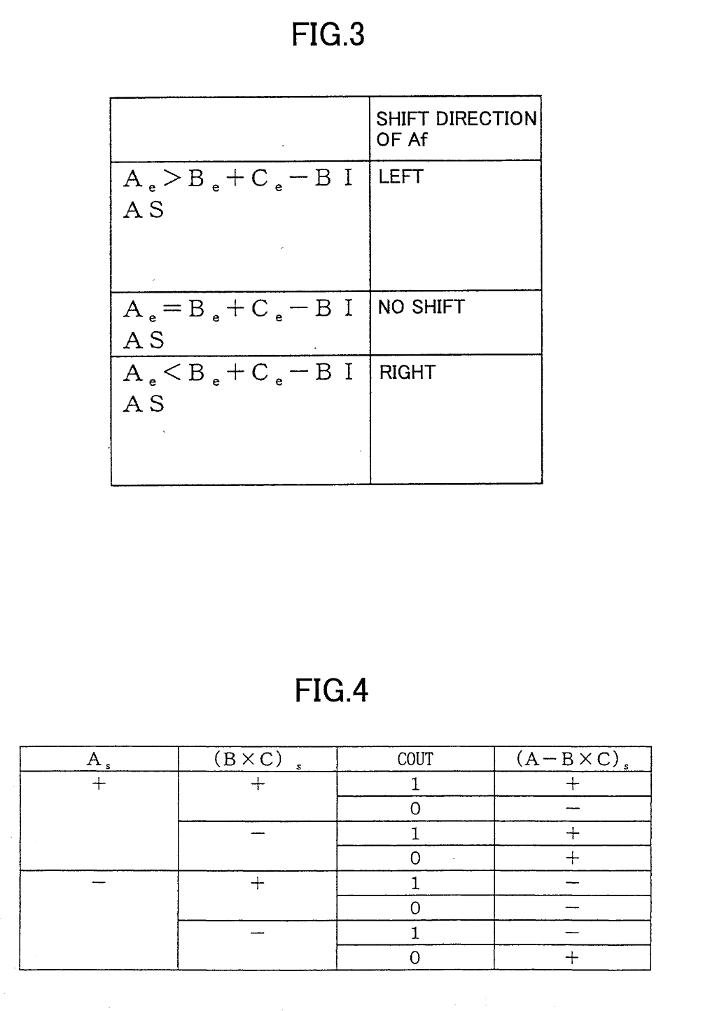

A first characterizing feature of the present invention utilizes the above described characteristics, and carries out a different process for the case where the remainder can be accurately obtained and the case where the remainder cannot be accurately obtained, so that the normalization and rounding unit 14 shown in FIG. 2 can be omitted. When the accurate remainder can be obtained, the exponent part of [(divisor)×(integer quotient)] when carrying out the product-sum operation and the exponent part of the dividend only differ by “1” at the most. For this reason, with regard to the alignment (shift) before the subtraction of the product-sum, it is sufficient if the shift amount enables a left-shift and a right-shift of a maximum of 1 bit.

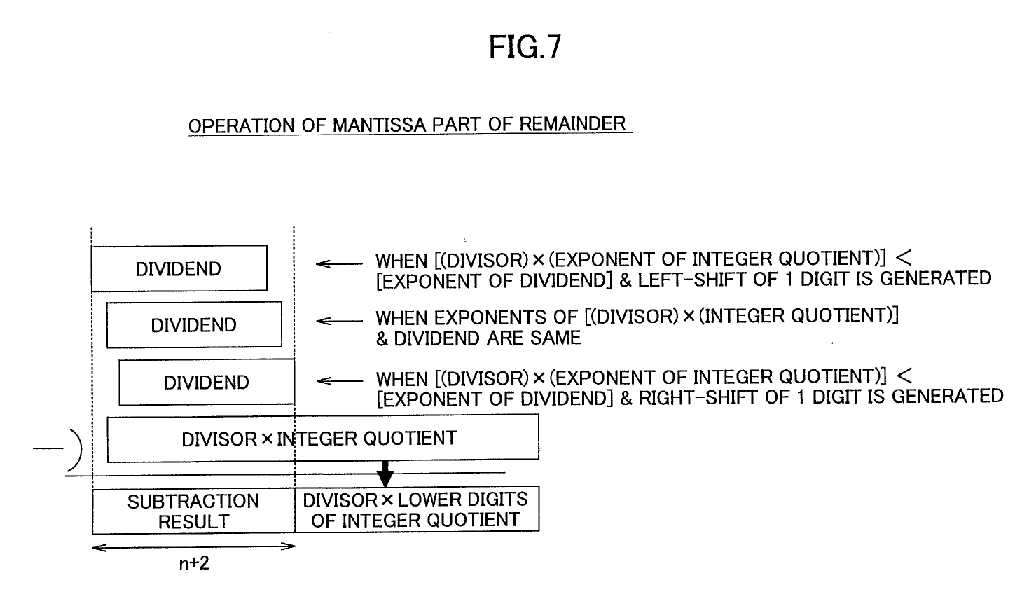

FIG. 7 is a diagram for explaining that a shift amount for aligning a dividend by an add-subtract process of a product-sum operation is a maximum of ±1 bit. As shown in FIG. 5, during the subtraction process of the product-sum operation, the alignment (shift) of the mantissa part is such that the dividend is shifted 1 bit to the left in a case where the rounding down is made when obtaining the integer quotient, and the dividend is shifted 1 bit to the right in a case where the rounding up is made when obtaining the integer quotient. Of course, the exponent part of the dividend and the exponent part of [(divisor)×(integer quotient)] may perfectly match, and the shift of the dividend is unnecessary in such a case. When a shift amount greater than 1 bit is generated, the integer quotient is in error since the obtained remainder becomes larger than the divisor.

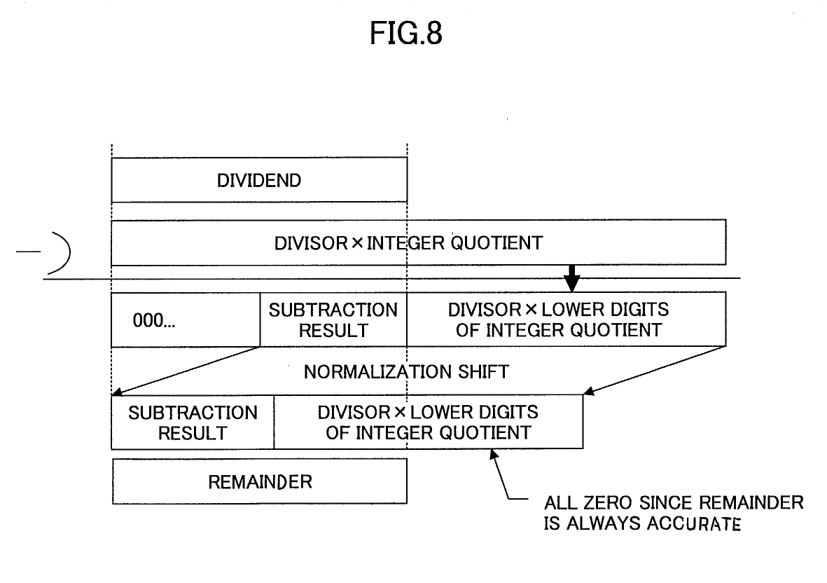

It is sufficient if the subtracter has a bit width of n+2 bits. However, a normalization shifter requires a bit width of 2n bits. This is because, when a normalization shift is carried out after the subtraction, an operand which is not subjected to a subtraction process and passed through may appear in the result, as shown in FIG. 8. FIG. 8 is a diagram for explaining the need for normalization of the remainder after an add-subtract process following multiplication in the product-sum operation.

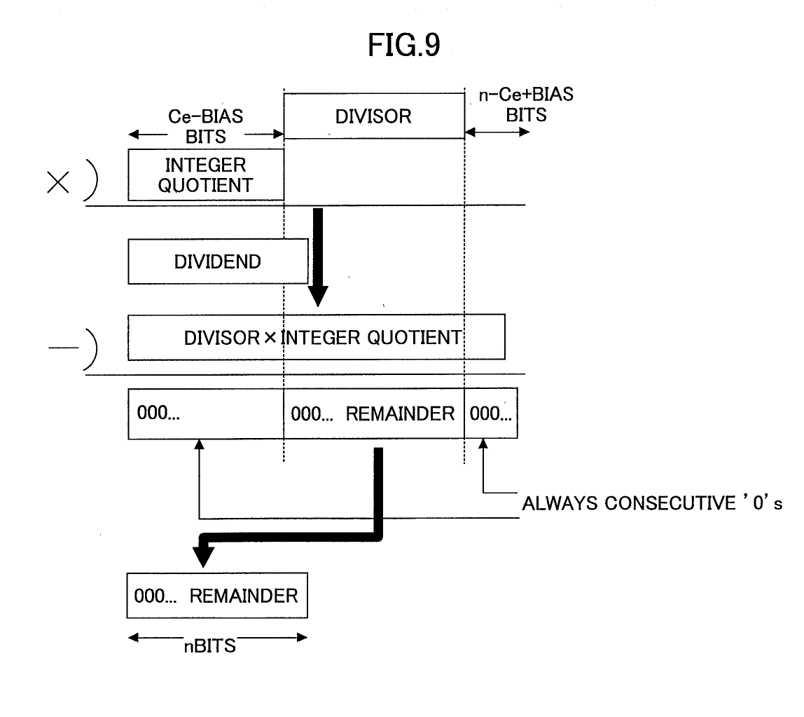

However, although the number of significant digits is Ce−BIAS bits when the integer quotient is regarded as a fixed-point, in the product-sum operation when obtaining the remainder, all of the Ce−BIAS bits from the start always become “0” by the subtraction of [(dividend)−{(divisor)×(integer quotient)}], and all of the n−Ce+BIAS bits from the rear end of [(divisor)×(integer quotient)] always become “0”, as shown in FIG. 9. FIG. 9 is a diagram for explaining that a normalization shift amount after the product-sum operation is predictable. If these conditions are not satisfied, the mantissa part of the obtained remainder becomes larger than the divisor, and the integer quotient is in error.

A second characterizing feature of the present invention utilizes the above described characteristics. In other words, the subtraction and the normalization shift in the product-sum operation are always carried out only with respect to n bits, by excluding Ce−BIAS bits from the start and n−Ce+BIAS bits from the rear end, so as to reduce the bit width of the computing unit. As a result, only n bits are required when carrying out the normalization shift after the addition.

On the other hand, if the dividend is 2n times or more larger than the divisor in absolute value and the number of significant digits Ce−BIAS of the integer quotient exceeds the number n of the bits of the mantissa part, the quotient cannot be represented by floating-point. In this case, the process of obtaining the quotient is discontinued during the process, and a quotient which is made up of only upper n bits of the significant digits of the quotient is obtained. Such a quotient is called a partial quotient. The partial quotient is obtained by carrying out the rounding process from a point which is n bits to the left of the mantissa part, and not from the decimal point, when obtaining the quotient, so that the mantissa part of the integer quotient always falls within n bits. A remainder which is obtained in this case is used in a subsequent process for obtaining a remaining integer quotient, and thus, the rounding mode is set to “Toward Zero” so that the remainder is always rounded down. For a case where n=24, for example,

1.0÷1.1×2⁻²⁷=101010101010101010101010101.0101 . . . (binary representation)

and the integer quotient is

“101010101010101010101010101”

or is rounded to

“101010101010101010101010110”

by being carried up by “1”. In either case, it is a partial case where the mantissa part of n=24 is exceeded. Hence, in order not to exceed the mantissa part of n=24, of the upper n bits, the 24th and subsequent bits are rounded by the “Toward Zero” to obtain the n-bit mantissa part. Accordingly, in this particular case, the 24th and subsequent bits of

“101010101010101010101010|101.0101 . . . ”

are rounded down, and the integer quotient

“101010101010101010101010|000.0000 . . . ”

is obtained.

Even in this case, the above described conditions are satisfied by multiplying the divisor by 2^{Ce-BIAS-n} and replacing the number Ce−BIAS of bits of the integer quotient by n. In the following description, the divisor is multiplied by 2^{Ce-BIAS-n} in the partial case, and the number Ce of bits of the integer quotient is replaced by n.

Next, a description will be given of a third characterizing feature of the present invention. As described above, the integer quotient is always ±1 when the remainder is inaccurate. In other words, the remainder can be obtained from the following formula.

(remainder)=(dividend)−(±1)×(divisor)

Since the number multiplied to the divisor is +1 or −1, no multiplication is required, and the operation can be realized by subtracting the divisor from the dividend when C=+1, and adding the divisor to the dividend when C=−1. This operation can be carried out using a floating-point adder which is provided as standard equipment in the processor of the computer, without the need to use a special circuit. The rounding process which is carried out when the remainder becomes inaccurate can be carried out by a rounding unit which is provided in the floating-point adder, without the need to use a rounding circuit exclusively for the remainder.

A fourth characterizing feature of the present invention enables a floating-point remainder operation utilizing the first, second and third characterizing features of the present invention, in an information processing apparatus having a FPU which is provided with known floating-point adder and floating-point multiplier.

The first and second characterizing features of the present invention relate to the remainder computing unit when the remainder can be obtained accurately. It is indicated that the inaccurate remainder is obtained only in a case where the integer quotient is ±1, and that in such a case, the third characterizing feature of the present invention obtains the remainder by a known floating-point adder-subtracter. Accordingly, it is possible to realize a floating-point remainder computing unit which can cope with the situation where the remainder is inaccurate, by carrying out one of two kinds of processes, namely, a process of obtaining the remainder by the floating-point adder-subtracter according to the third characterizing feature of the present invention if the integer quotient obtained as a result of the division is ±1, and a process of otherwise obtaining the remainder by the floating-point remainder computing unit according to the first or second characterizing feature of the present invention.

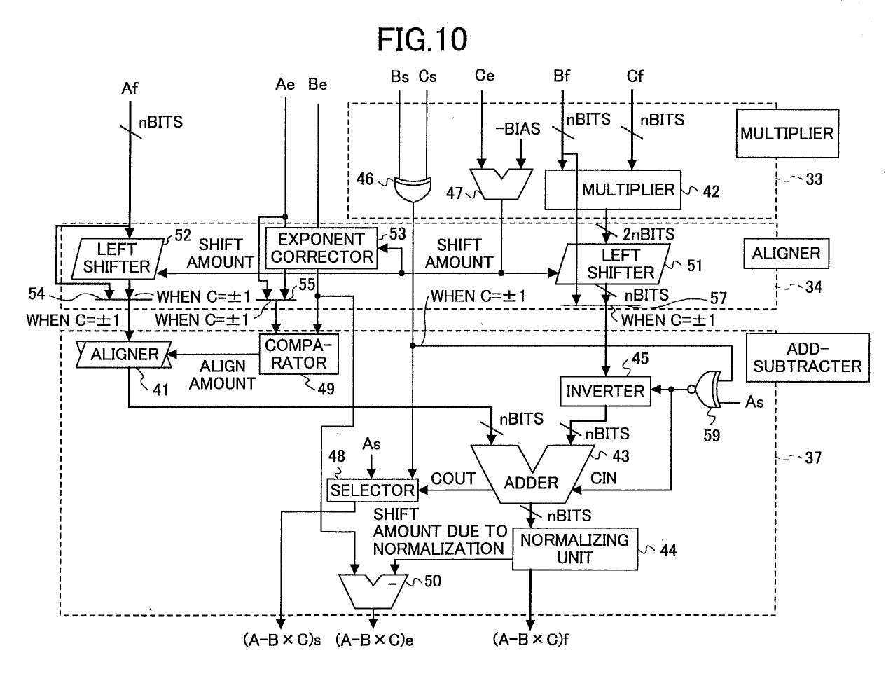

Next, a description will be given of an embodiment of an product-sum operation circuit of the floating-point remainder computing unit according to the present invention, by referring to FIG. 10. FIG. 10 is a system block diagram showing an important part of this embodiment of the product-sum operation circuit of the floating-point remainder computing unit according to the present invention. In this embodiment, the floating-point remainder computing unit employs the first and second characterizing features of the present invention using a product-sum computing unit.

The present inventor has found that the multiplication and subtraction during the product-sum operation may be carried out using an n-bit mantissa part. Hence, the floating-point multiplier and the floating-point adder which are provided as standard equipment in the FPU of the processor within the computer are utilized by making only a slight modification. For this reason, it is unnecessary to provide an operation unit exclusively for the product-sum operation, and the amount of the required hardware can be reduced considerably.

In FIG. 10, As denotes a sign of the floating-point dividend A, Ae denotes an exponent of the floating-point dividend A, Af denotes a mantissa of the floating-point dividend A, Bs denotes a sign of the floating-point divisor B, Be denotes an exponent of the floating-point divisor B, Bf denotes a mantissa of the floating-point divisor B, Cs denotes a sign of the quotient C, Ce denotes an exponent of the quotient C, Cf denotes a mantissa of the quotient C, and BIAS denotes a bias value of an exponent part of the floating-point number. In addition, it is assumed that n denotes a number of bits of the mantissa part. In FIG. 10, a product-sum operation circuit of the floating-point remainder computing unit includes a floating-point multiplier 33, an aligner 34 and a floating-point adder-subtracter 37.

The floating-point multiplier 33 includes a multiplier 42, an exclusive-OR circuit 46 and an exponent part adder 47. The multiplier 42 receives the n-bit mantissa part as an input operand, and outputs a 2n-bit multiplication result. The exclusive-OR circuit 46 generates the sign of the multiplication result of A and B by exclusive-OR. The exponent part adder 47 obtains the exponent part of the multiplication result of A and B.

In the remainder operation, the remainder is computed not by supplying the final multiplication result of the floating-point multiplier 33, but by supplying an intermediate result within the floating-point multiplier 33 to the aligner 34 which will be described later. Accordingly, although an exponent part calculation circuit and a rounding circuit for the mantissa part of the result are required additionally in the floating-point multiplier 33 in order to form a complete floating-point multiplier, the illustration of such parts in the floating-point multiplier 33 is omitted in FIG. 10 because such parts are not required for the remainder operation.

The aligner 34 includes a left shifter 51, a left shifter 52, an exponent part corrector 53, and selectors 54, 55 and 57. The left shifter 51 shifts the 2n-bit mantissa part of the multiplication result of the multiplier 42 to the left by Ce-BIAS bits, and outputs only the upper n bits by rounding down the lower bits. The left shifter 52 shifts Af to the left by Ce−BIAS bits. The exponent part corrector 53 subtracts Ce from Ae and adds the BIAS value so as to match the exponent to the results of the left-shift of the mantissa parts in the left shifters 51 and 52. The selector 54 selects Af or Af<<Ce−BIAS as the mantissa part of a first operand OP1 of the floating-point adder-subtracter 37. The selector 55 selects Ae or Ae−Ce+BIAS as the exponent part of the first operand OP1 of the floating-point adder-subtracter 37. The selector 57 selects Bf or Bf×Cf<<Ce−BIAS as the mantissa part of a second operand OP2 of the floating-point adder-subtracter 37.

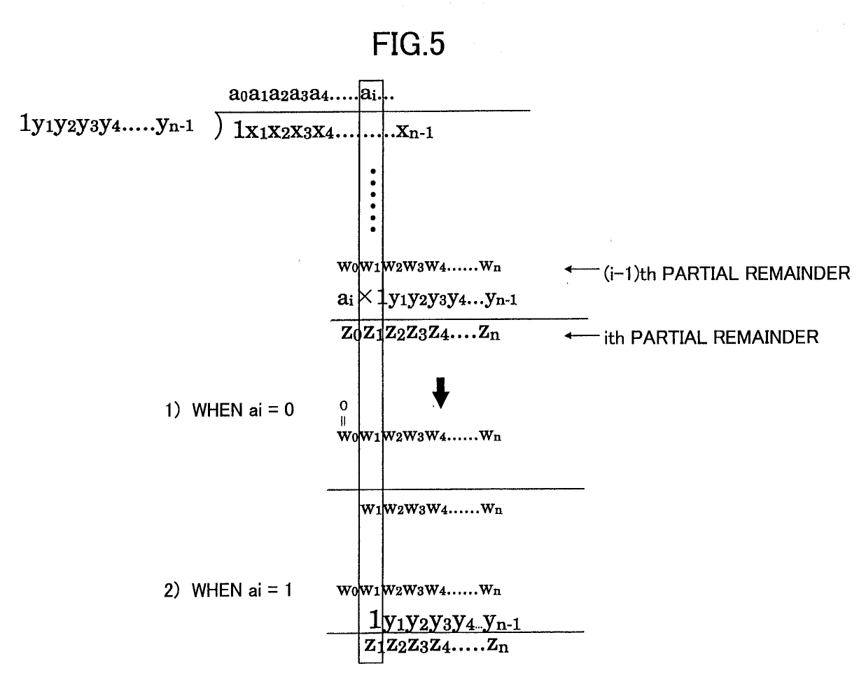

The floating-point adder-subtracter 37 includes an aligner 41, an absolute value adder 43, a normalizing unit 44, an inverter 45, a selector 48, a comparator 49, an exponent part subtracter 50 and an exclusive-NOR circuit 59. The aligner 41 is provided as an aligner with respect to the first operand OP1 of the floating-point adder-subtracter 37. The normalizing unit 44 normalizes the n-bit mantissa part, outputs an n-bit mantissa part, and simultaneously outputs a shift amount with which a left-shift is made by the normalization. The inverter 45 inverts the mantissa part of the multiplication result if the inversion of the exclusive-OR of As, Bs and Cs obtained from the exclusive-NOR circuit 59 is “1”. A carry CIN from the exclusive-NOR circuit 59 is input to a least significant digit of the absolute value adder 43. The selector 48 obtains the sign of A−B×C as shown in FIG. 4, from the sign of A×B, the sign of C and a carry out COUT of the absolute value adder 43. The comparator 49 compares the exponent parts of A×B and C, and obtains an alignment amount of A. The exponent part subtracter 50 subtracts the left-shift amount output from the normalizing unit 44 from (B×C)e, and obtains the exponent part of the final result.

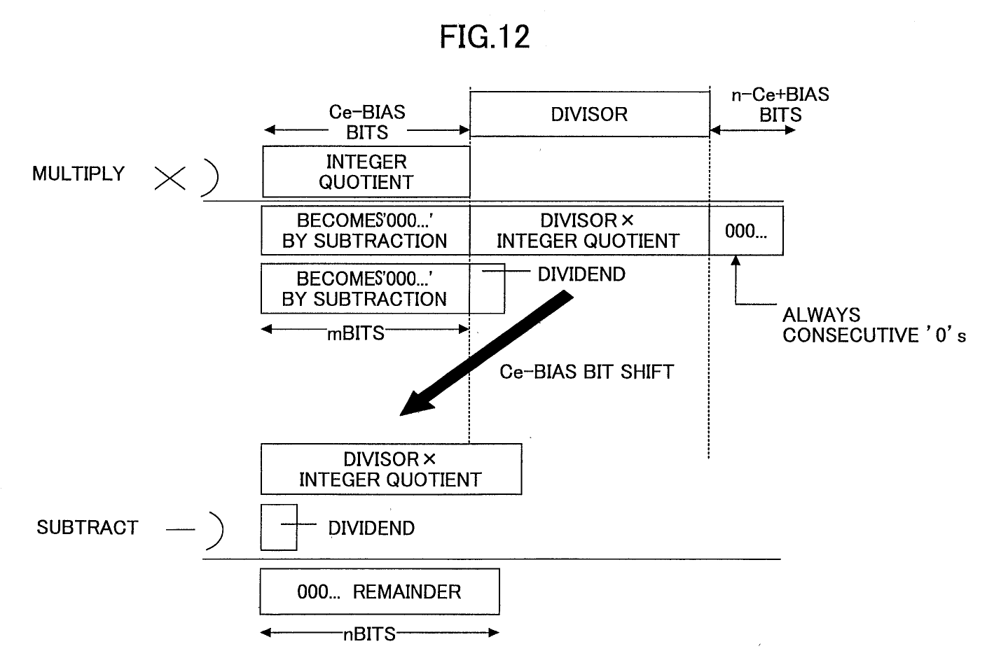

The floating-point multiplier 33 is made of a known floating-point multiplier. However, the mantissa part and the exponent part of the operation result are corrected by the left shifter 51. The mantissa part is shifted to the left by Ce−BIAS bits, and the n bits on the right side are rounded down so as to obtain an n-bit multiplication result. The exponent part Be+Ce−BIAS which is obtained as a result of the multiplication is not required in the subsequent processes, and thus, the illustration of the exponent part is omitted in FIG. 10. With regard to the mantissa part, the floating-point multiplier 33 is actually provided with a rounding unit for rounding the 2n-bit output of the multiplier 42 to an n-bit output. However, a 2n-bit intermediate result of the floating-point multiplication output from the multiplier 42 is used in the remainder operation of this embodiment, and thus, an illustration and description of the rounding unit in the stage subsequent to the multiplier 42 will be omitted. The meaning of the above described operation with respect to the multiplication result will be described later in conjunction with FIG. 12. As described above under the second characterizing feature of the present invention, all of the upper Ce−BIAS bits of the mantissa part of the multiplication result become “0” by the add-subtract operation following the multiplication, and all of the n−Ce+BIAS bits on the right side of the mantissa part of the multiplication result always become “0”. Accordingly, since these bits do not affect the subsequent operations, these bits are deleted at this stage so as to reduce the bit width of the mantissa part from 2n bits to n bits.

In addition, the dividend which becomes the other operand of the floating-point adder-subtracter 37 is also similarly subjected to a correction process by the left shifter 52 and the exponent part corrector 53. The mantissa part is shifted to the left by Ce−BIAS bits, and Ce−BIAS is subtracted from the exponent part.

A floating-point adder-subtracter which is provided as standard equipment in the processor of the computer may be used as the floating-point adder-subtracter 37.

Therefore, in the floating-point remainder computing unit according to the first and second characterizing feature of the present invention, the operands are selected by the selectors 54, 55 and 57 so that the following floating-point remainder is computed from A−B×C, and the process is carried out for the case where the remainder is accurate. In addition, in the floating-point remainder computing unit according to the third characterizing feature of the present invention, the process is carried out for the case where the remainder is inaccurate, similarly to the known floating-point adder-subtracter. The floating-point remainder computing unit according to the third characterizing feature of the present invention can substantially be formed by the known floating-point adder-subtracter 37.

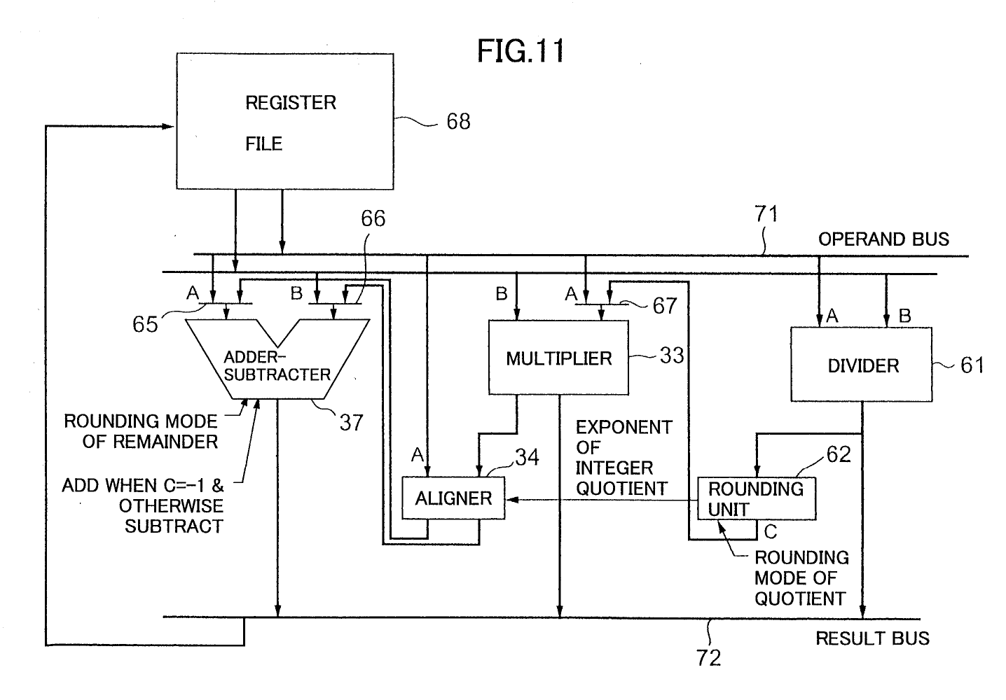

By employing the structure shown in FIG. 10, the additional hardware required for the product-sum operation is only a correction circuit for the product-sum operation, including the left shifters 51 and 52 and the exponent part corrector 53. A selection circuit formed by the selectors 54, 55 and 57 determines whether the operation which is to be carried out in the floating-point adder-subtracter 37 of the subsequent stage is A−B×C or A−B. The operation A−B is required in order to realize the fourth characterizing feature of the present invention which will be described later in conjunction with FIG. 11.

FIG. 11 is a system block diagram showing an embodiment of the information processing apparatus according to the present invention. This embodiment of the information processing apparatus employs the above described embodiment of the floating-point remainder computing unit, and has the fourth characterizing feature of the present invention.

According to the fourth characterizing feature of the present invention, the information processing apparatus is formed by a FPU having the second and third characterizing features of the present invention. The FPU within the information processing apparatus having the fourth characterizing feature of the present invention becomes as shown in FIG. 11. The FPU includes a floating-point remainder computing unit which is made up of the floating-point multiplier 33, the aligner 34 and the floating-point adder-subtracter 37. A floating-point multiplication result is output from a right output of the floating-point multiplier 33, and an intermediate result of the floating-point multiplication is output from a left output of the floating-point multiplier 33. As described above, the remainder operation is carried out by supplying the intermediate result of the floating-point multiplication to the aligner provided in the subsequent stage. FIG. 11 also shows a floating-point divider 61, a rounding unit 62 for rounding an input to an integer, selectors 65, 66 and 67, a floating-point register file 68, an operand bus 71, and a result bus 72. The information processing apparatus is also provided with a controller, a memory and the like in addition to the FPU, but the illustration and description thereof will be omitted because the basic structure itself of this information processing apparatus is known.

If the integer quotient C is other than ±1, the left-shifted result from the aligner 34 becomes the first and second operands OP1 and OP2 of the floating-point adder-subtracter 37 via the selectors 65 and 66 shown in FIG. 11, as described above in conjunction with the first and second characterizing features of the present invention. On the other hand, if the integer quotient C is ±1, A becomes the first operand OP1 and B becomes the second operand OP2 of the floating-point adder-subtracter 37 via the selectors 65 and 66 shown in FIG. 11, and A and B are subjected to the add-subtract operation, as described above in conjunction with the third characterizing feature of the present invention. In this latter case, the floating-point adder-subtracter 37 carries out a subtraction if C=+1, and carries out an addition if C=−1. A result which is obtained via the result bus 72 is input to the register file 68, and an output obtained from the register file 68 is input via the operand bus 71 to the selectors 65 through 67, the floating-point multiplier 33m the aligner 34 and the floating-point divider 61.

FIG. 12 is a diagram for explaining an alignment of A and B×C by the aligner 34 shown in FIG. 11.

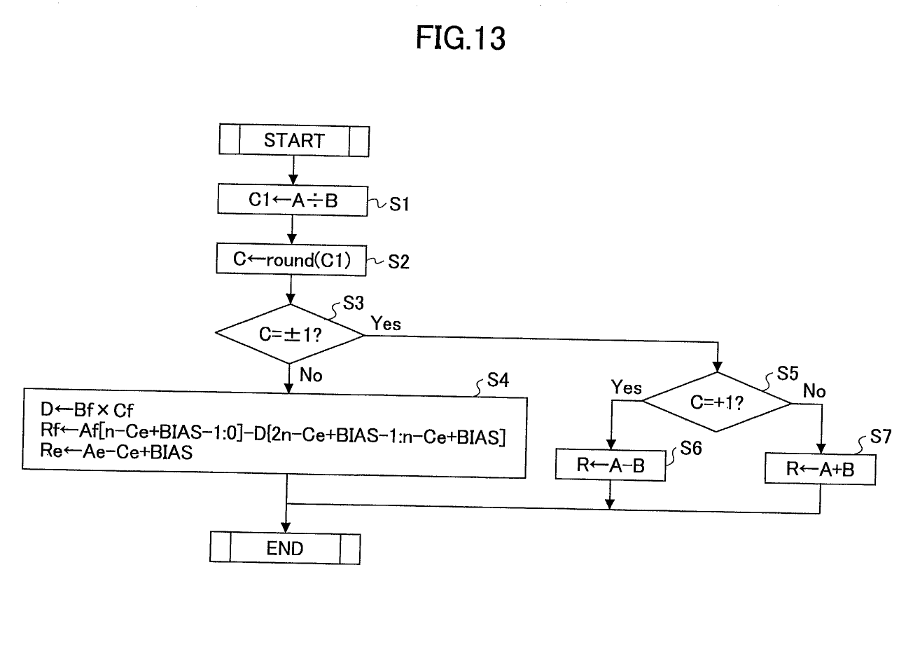

The above described embodiment of the information processing apparatus may be realized by software. A flow chart for this case becomes as shown in FIG. 13. FIG. 13 is a flow chart for explaining a computer program stored in an embodiment of the computer-readable storage medium according to the present invention. The computer-readable storage medium may be formed by any type of recording media capable of storing the computer program, such as magnetic, magneto-optical and optical recording media such as disks and cards, and semiconductor memory devices, which are known, and an illustration of the recording medium will be omitted. The computer program may be downloaded by a computer to the computer-readable storage medium by a known means via a network, for example. The computer program causes the computer which is made up of the processor and the like to carry out the process shown in FIG. 13.

In the following, floating-point variables are denoted by A, B, C, C1 and R, an integer variable is denoted by D, exponent parts of the floating-point variables A, B, C, C1 and R are respectively denoted by Ae, Be, Ce, C1e and Re, and mantissa parts of the floating-point variables A, B, C, C1 and R are respectively denoted by Af, Bf, C, C1f and Rf. In addition, it is assumed that the bit width of the mantissa part is n bits, the bit width of the variable D is 2n bits, and a quotient and a remainder of a division A÷B are respectively denoted by C and R. In this case, a step S1 shown in FIG. 13 obtains C1 from A÷B. A step S2 rounds C1, and the integer quotient is obtained by the variable C. A step S3 compares C and +1 to decide whether or not C=+1. If the decision result in the step S3 is NO, the remainder can be obtained accurately, and the process advances to a step S4.

The step S4 processes the floating-point variables B and C by separating these floating-point variables B and C into the mantissa part and the exponent part. First, a 2n-bit multiplication result obtained by multiplying Bf and Cf is substituted into D. Next, D is subtracted from Af, but since it is known that the upper Ce−BIAS bits of this subtraction result will all be “0”, the bits [2n−Ce+BIAS−1:n−Ce+BIAS] of D are subtracted from the bits [n−Ce+BIAS−1:0] of Af. The bit width of Af[n−Ce+BIAS−1:0] is smaller than the bit width of D[2n−Ce+BIAS−1:n−Ce+BIAS], but because the bit weight of the most significant bit is the same for the two, the subtraction is carried out between the two by aligning to the left so that the most significant bits of the two match. The subtraction result is substituted into Rf. Then, Ae−Ce+BIAS is calculated and substituted into Re. The mantissa part Rf and the exponent part Re of the remainder R are separately obtained in this manner.

On the other hand, if the decision result in the step S3 is YES, there is a possibility that the remainder cannot be obtained accurately. Hence, a step S5 decides whether or not C=+1. If C=+1 and the decision result in the step S5 is YES, a step S6 obtains the remainder by carrying out R← A−B. On the other hand, if C=−1 and the decision result in the step S5 is NO, a step S7 obtains the remainder by carrying out R← A+B. The add-subtract process of the steps S6 and S7 is carried out between floating-points, and an error may be generated due to the rounding process. The rounding process of this floating-point add-subtract process is used for the remainder rounding process in the case where the remainder is inaccurate. For this reason, the rounding mode should match the rounding mode of the remainder operation.

Therefore, by combining the first and second characterizing features of the present invention, it is possible to omit the floating-point multiplier and the floating-point adder-subtracter which are conventionally required for processing the mantissa part having the bit width of 2n bits. In addition, because the present inventor has found that the bit width of the mantissa part may be n bits if the remainder can be obtained accurately, it is possible to effectively utilize the floating-point multiplier and the floating-point adder-subtracter which are provided as standard equipment in the computer. As a result, it is possible to realize the floating-point remainder computing unit without increasing the scale of the hardware.

In addition, according to the first and second characterizing features of the present invention, the integer quotient is ±1 if the remainder is inaccurate. Furthermore, according to the third characterizing feature of the present invention, the multiplication is not required if the remainder is inaccurate, and the remainder can be obtained by carrying out only the add-subtract operation. Hence, the rounding process of the remainder operation can be processed by the floating-point adder-subtracter, and the rounding unit for rounding the result of the remainder operation can be omitted.

Moreover, according to the fourth characterizing feature of the present invention, it is possible to form the information processing apparatus by the FPU which is provided with the second and third characterizing features of the present invention or is further provided with the fourth characterizing feature of the present invention.

Further, the present invention is not limited to these embodiments, but various variations and modifications may be made without departing from the scope of the present invention.

What is claimed is

1. A floating-point remainder computing unit for computing a remainder R, where floating-point variables are denoted by A, B, C and R, an exponent part and a mantissa part of the floating-point variable R are respectively denoted by Re and Rf, and an integer quotient obtained by rounding a quotient of A÷B is denoted by C, said floating-point remainder computing unit comprising:
a judging section obtaining the integer quotient by the variable C by rounding the floating-point variable C which is obtained from A÷B, and judging whether or not the remainder R can be obtained accurately, based on a comparison result of the variable C and ±1;
a first operation section separately processing mantissa parts and exponent parts of the floating-point variables B and C, and separately obtaining the mantissa part Rf and the exponent part Re of the remainder R, if said judging section judges that the remainder R can be obtained accurately; and
a second operation section carrying out a floating-point add-subtract process which obtains the remainder R from A−B if C=+1 and obtains the remainder R from A+B if C=−1, if said judging section judges that the remainder R cannot be obtained accurately.

2. The floating-point remainder computing unit as claimed in claim 1, wherein:
an integer variable is denoted by D;
exponent parts of the floating-point variables A, B, C and C1 are respectively denoted by Ae, Be, Ce and C1e;
mantissa parts of the floating-point variables A, B, C and Cl are respectively denoted by Af, Bf, Cf and C1f;
a bit width of the mantissa part is n bits;
a bit width of the integer variable D is 2n bits;
a bias value of an exponent part of a floating-point number is denoted by BIAS; and
said first operation section separately obtains the mantissa part Rf and the exponent part Re of the remainder R by substituting a 2n-bit multiplication result obtained by multiplying Bf and Cf into D, subtracts bits [2n−Ce+BIAS−1:n−Ce+BIAS] of D from bits [n−Ce+BIAS−1:0] of Af by aligning the two to the left so that most significant bits of the two match, substitutes a subtraction result into Rf, and calculates and substitutes Ae−Ce+BIAS into Re.

3. The floating-point remainder computing unit as claimed in claim 1, wherein said second operation section applies a rounding process of the floating-point add-subtract process to a rounding process of the remainder R for a case where the remainder R cannot be obtained accurately.

4. The floating-point remainder computing unit as claimed in claim 1, wherein said judging section judges that the remainder R cannot be obtained accurately unless the integer quotient C is C=±1.

5. An apparatus comprising:
a floating-point operation unit having a floating-point remainder computing unit for computing a remainder R, where floating-point variables are denoted by A, B, C and R, an exponent part and a mantissa part of the floating-point variable R are respectively denoted by Re and Rf, and an integer quotient obtained by rounding a quotient of A÷B is denoted by C,
said floating-point remainder computing unit comprising:
a judging section obtaining the integer quotient by the variable C by rounding the floating-point variable C which is obtained from A÷B, and judging whether or not the remainder R can be obtained accurately, based on a comparison result of the variable C and ±1;
a first operation section separately processing mantissa parts and exponent parts of the floating-point variables B and C, and separately obtaining the mantissa part Rf and the exponent part Re of the remainder R, if said judging section judges that the remainder R can be obtained accurately; and
a second operation section carrying out a floating-point add-subtract process which obtains the remainder R from A−B if C=+1 and obtains the remainder R from A+B if C =−1, if said judging section judges that the remainder R cannot be obtained accurately.

6. The apparatus as claimed in claim 5, wherein:
an integer variable is denoted by D;
exponent parts of the floating-point variables A, B, C and C1 are respectively denoted by Ae, Be, Ce and C1e;
mantissa parts of the floating-point variables A, B, C and C1 are respectively denoted by Af, Bf, Cf and C1f;
a bit width of the mantissa part is n bits;
a bit width of the integer variable D is 2n bits;
a bias value of an exponent part of a floating-point number is denoted by BIAS; and
said first operation section of the floating-point remainder computing unit separately obtains the mantissa part Rf and the exponent part Re of the remainder R by substituting a 2n-bit multiplication result obtained by multiplying Bf and Cf into D, subtracts bits [2n−Ce+BIAS−1:n−Ce+BIAS] of D from bits [n−Ce+BIAS−1:0] of Af by aligning the two to the left so that most significant bits of the two match, substitutes a subtraction result into Rf, and calculates and substitutes Ae−Ce+BIAS into Re.

7. The apparatus as claimed in claim 5, wherein said second operation section of the floating-point remainder computing unit applies a rounding process of the floating-point add-subtract process to a rounding process of the remainder R for a case where the remainder R cannot be obtained accurately.

8. The apparatus as claimed in claim 5, wherein said judging section of the floating-point remainder computing unit judges that the remainder R cannot be obtained accurately unless the integer quotient C is C=±1.

9. A computer-readable storage medium which stores a computer program for causing a computer to carry out a floating-point remainder operation which computes a remainder R, where floating-point variables are denoted by A, B, C and R, an exponent part and a mantissa part of the floating-point variable R are respectively denoted by Re and Rf, and an integer quotient obtained by rounding a quotient of A÷B is denoted by C, said computer program comprising:
a judging procedure which causes the computer to obtain the integer quotient by the variable C by rounding the floating-point variable C which is obtained from A÷B, and judge whether or not the remainder R can be obtained accurately, based on a comparison result of the variable C and ±1;
a first operation procedure which causes the computer to separately process mantissa parts and exponent parts of the floating-point variables B and C, and separately obtain the mantissa part Rf and the exponent part Re of the remainder R, if said judging procedure judges that the remainder R can be obtained accurately; and
a second operation procedure which causes the computer to carry out a floating-point add-subtract process which obtains the remainder R from A−B if C=+1 and obtains the remainder R from A+B if C=−1, if said judging procedure judges that the remainder R cannot be obtained accurately.

10. The computer-readable storage medium as claimed in claim 9, wherein:
an integer variable is denoted by D;
exponent parts of the floating-point variables A, B, C and C1 are respectively denoted by Ae, Be, Ce and C1e;
mantissa parts of the floating-point variables A, B, C and C1 are respectively denoted by Af, Bf, Cf and C1f;
a bit width of the mantissa part is n bits;
a bit width of the integer variable D is 2n bits;
a bias value of an exponent part of a floating-point number is denoted by BIAS; and
said first operation procedure causes the computer to separately obtain the mantissa part Rf and the exponent part Re of the remainder R by substituting a 2n-bit multiplication result obtained by multiplying Bf and Cf into D, subtract bits [2n−Ce+BIAS−1:n−Ce+BIAS] of D from bits [n−Ce+BIAS−1:0] of Af by aligning the two to the left so that most significant bits of the two match, substitute a subtraction result into Rf, and calculate and substitute Ae−Ce+BIAS into Re.

11. The computer-readable storage medium as claimed in claim 9, wherein said second operation procedure causes the computer to apply a rounding process of the floating-point add-subtract process to a rounding process of the remainder R for a case where the remainder R cannot be obtained accurately.

12. The computer-readable storage medium as claimed in claim 9, wherein said judging procedure causes the computer to judge that the remainder R cannot be obtained accurately unless the integer quotient C is C=±1.
